(19) United States
(12) Patent Application Publication
(10) Pub. No.: US 2008/0072091 A1
(43) Pub. Date: Mar. 20, 2008

(54) FUEL CELL BASED BATTERY BACKUP APPARATUS FOR STORAGE SUBSYSTEMS

(76) Inventors: George E. Hanson, Andover, KS (US); Sean G. Winter, Wichita, KS (US)

Correspondence Address: LSI CORPORATION, 1621 BARBER LANE, MS: D-106, MILPITAS, CA, 95035, US

(21) Appl. No.: 11/863,688

(22) Filed: Sep. 28, 2007

Related U.S. Application Data
(62) Division of application No. 10/244,575, filed on Sep. 16, 2002.

(51) Int. Cl. G06F 1/26

(52) U.S. Cl. 713/340

(57) ABSTRACT

Fuel cell based backup unit apparatus for storage subsystems are provided. With the apparatus, at least one fuel cell is provided as part of a fuel cell power generation array that is used to provide backup power to a storage subsystem of a computing device, such as a RAM cache. A regeneration mechanism is provided for regenerating the fuel in the at least one fuel cell. A logic and control module is provided for controlling the overall operation of the backup unit including determining when to provide backup power and when to initiate regeneration of the fuel cells. A DC/DC voltage conversion module may also be provided for converting a DC output from the fuel cell power generation array into an output useable by the storage subsystem. In a hybrid embodiment, both a fuel cell power generation array and a lead-acid battery pack cache backup array may be utilized to provide backup power for a storage subsystem. In such a hybrid embodiment, the fuel cells of the fuel cell power generation array may provide backup power to the storage subsystem and/or provide a recharge voltage for recharging the lead-acid batteries in the lead-acid battery pack cache backup array.

### BACKGROUND OF THE INVENTION

1. Technical Field

The present invention is directed to fuel cell based battery backup apparatus for storage subsystems.

2. Description of Related Art

Controller modules constitute one of the critical component types that make up storage subsystems. Controllers handle data in a very rapid fashion. In order to achieve high effective data transfer rates, caching is often used. Since caching is typically used, data is often resident within on-board RAM inside of the controller modules waiting to be striped onto attached disk drives. This data is vulnerable to losses of system power. Should a storage system lose power, even momentarily, the data stored in the on-board RAM is in danger of being lost. This is why controller subsystems usually take advantage of battery backup systems.

Battery backup systems, in at least one implementation, serve to maintain power to circuitry that protects the data resident within the cache RAM. Conventionally, backup units have been rated by the number of days that they are capable of supporting cache RAM. It is common to see battery backup systems with hold-up times of between three and seven or more days.

Battery systems are usually tested for their endurance and it is common for back-up battery packs to support cache RAM for periods equal to or greater than double their rated hold-up time. The difference is attributed to insurance against aging and environmental conditions.

Several battery technologies are available to the designer of back-up systems. The first of these is Ni—Cd (Nickel Cadmium) batteries. The Ni—Cd type battery has several idiosyncrasies that make it only a marginal option for a back-up unit power source. Cadmium is toxic and its use raises several significant disposal issues. Ni—Cd batteries need to be periodically discharged completely to achieve an acceptable life span. Backup units typically float charge their contained batteries continuously. This would shortly destroy Ni—Cd batteries. Thus Ni—Cd batteries do not make an acceptable choice for use in battery backup systems for storage subsystems.

Nickel Metal Hydride batteries are different than Nickel Cadmium but have some of the same operating characteristics. They also need to be periodically discharged to preserve their life expectancy and are more temperature dependent. Even though their name does not suggest so, they still contain cadmium and thus, disposal issues are prominent.

Very often lead-acid batteries are used. This older technology energy storage system also has its problems. Such batteries have finite lives and those lives are defined by the number of deep cycles they experience and the environments that they are forced to exist within. Heat is a problem with lead acid batteries and a warm environment translates to a shortened life span. Current lead-acid technologies are limited to life spans of two to three years. There is also a disposal issue with both the lead and with the sulfuric acid contained within lead-acid batteries.

Lithium Ion batteries are new and are considered to be a contender well poised to replace lead-acid batteries in storage systems. These batteries still have their problems, however. First, they are thermally sensitive and must be thermally monitored during operation to verify that they are at operational temperatures. Second, currents are limited in order to maintain operational temperatures. Since the current is limited, large arrays of cells are required to accomplish functions that are not capacity limited.

Voltages must be tightly controlled in charging. Low voltage conditions exist where these batteries might be damaged unless they are “conditioned” before charging. Lithium Ion batteries cost several times what similar capacities in lead-acid batteries would cost. They also have a reputation for being dangerous—there have been notable incidents where these batteries have exploded during operation and thus, circuit protection is required to prevent such explosions from happening. Disposal is not an issue for this type of battery since lithium is not considered a toxic material.

Thus, each of these possible battery choices have numerous problems making them sub-optimal options for use in battery backup systems. It would therefore be beneficial to have a fuel cell based backup unit apparatus and method for a storage subsystem that does not suffer from the problems of these other options.

### SUMMARY OF THE INVENTION

The present invention provides a fuel cell based backup unit apparatus for a storage subsystem. With the apparatus and method of the present invention, at least one fuel cell is provided as part of a fuel cell power generation array that is used to provide backup power to a storage subsystem of a computing device, such as a RAM cache. A regeneration mechanism is provided for regenerating the fuel in the at least one fuel cell. The regeneration mechanism may provide an electrical current for reversing a chemical reaction to regenerate the chemical reactants, provide additional chemicals, such as methanol, for use in providing additional power, or the like. A logic and control module is provided for controlling the overall operation of the backup unit including determining when to provide backup power and when to initiate regeneration of the fuel cells. A DC/DC voltage conversion module may also be provided for converting a DC output from the fuel cell power generation array into an output useable by the storage subsystem.

In a hybrid embodiment, both a fuel cell power generation array and a lead-acid battery pack cache backup array may be utilized to provide backup power for a storage subsystem. In such a hybrid embodiment, the fuel cells of the fuel cell power generation array may provide backup power to the storage subsystem and/or provide a recharge voltage for recharging the lead-acid batteries in the lead-acid battery pack cache backup array. A recharge power routing and selection mechanism may be provided to determine which operation, either power backup or recharge of the lead-acid batteries, is to be performed by the output from the fuel cells based on instructions from the logic and control module. These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram illustrating a fuel cell based backup unit in accordance with an exemplary embodiment of the present invention;

FIG. 2 is an exemplary diagram of a zinc-air fuel cell backup unit in accordance with an exemplary embodiment of the present invention;

FIG. 3 is an exemplary diagram of a methanol based fuel cell backup unit in accordance with an exemplary embodiment of the present invention;

FIG. 4 is an exemplary diagram of a hybrid fuel cell and lead acid battery backup unit in accordance with an exemplary embodiment of the present invention; and

FIG. 5 is an exemplary diagram of a hybrid methanol fuel cell and lead acid battery backup unit in accordance with an exemplary embodiment of the present invention.

### DETAILED DESCRIPTION

The present invention provides a new backup unit for storage subsystems in which fuel cells are used to provide power to the storage subsystem in the event of a primary power source failure or other interruption of power. In addition, the present invention provides a hybrid battery backup unit in which both fuel cells and lead acid batteries may be used to provide battery backup power. With the present invention, reliable battery backup power is provided while avoiding the many drawbacks of known battery backup units.

Both fuel cells and batteries are electrochemical power sources. The difference between the concepts of fuel cells and batteries is that batteries are charged electrically while fuel cells are charged by supplying additional fuel. In other words, reactants are added to a fuel cell to “recharge” it. Refueling a fuel cell takes minutes but recharging a battery may require several hours. Similarly, while reactants are added to a fuel cell to recharge the fuel cell, electrical charge is added to a battery to cause the reactants to return to an initial state.

While the concept of fuel cells has been known for some time, the application of fuel cells in backup units for storage subsystems has not been known or even suggested prior to the present invention. Currently, fuel cells are used in large applications, such as power sources for vehicles, backup power sources for homes and businesses, and the like. There has been no recognition prior to the present invention of the advantages that may be obtained from using fuel cells in a battery backup unit for a storage subsystem, as described herein.

To illustrate the differences between a fuel cell approach to storage subsystem battery backup units and conventional lead-acid battery backup systems, consider current backup systems in storage subsystems. These systems generally comprise an interface to the subsystem, charging circuitry and batteries to store power. Those batteries tend to be lead-acid batteries due to the environment and type of usage that these batteries are expected to endure. Lithium Ion batteries may be appropriate for some installations but these tend to be costly and have some limitations that preclude their use in some applications. These aspects are dealt with in other portions of this document.

The interface circuitry has some logic and monitoring circuitry that keeps track of the battery status. When the subsystem asserts a “Request” command it is the function of this logic to determine whether to assert a “Grant” command in response. The lack of a “Grant” command suspends caching in the subsystem. The interface circuitry also selects and implements the remedial actions necessary to bring the batteries to a state where the “Grant” response can be asserted.

The batteries generally are selected for their extensive capacity. In service they are not usually called upon to deliver great current but are required to supply those currents for long times. A recent battery duration test showed that over a period of 22 days, typical currents were on the order of 30 ma.

The backup unit also includes a charger that implements a battery technology specific algorithm for maintaining an acceptable level of charge. This ensures a reasonable expectation of reaching at least a minimal backup duration.

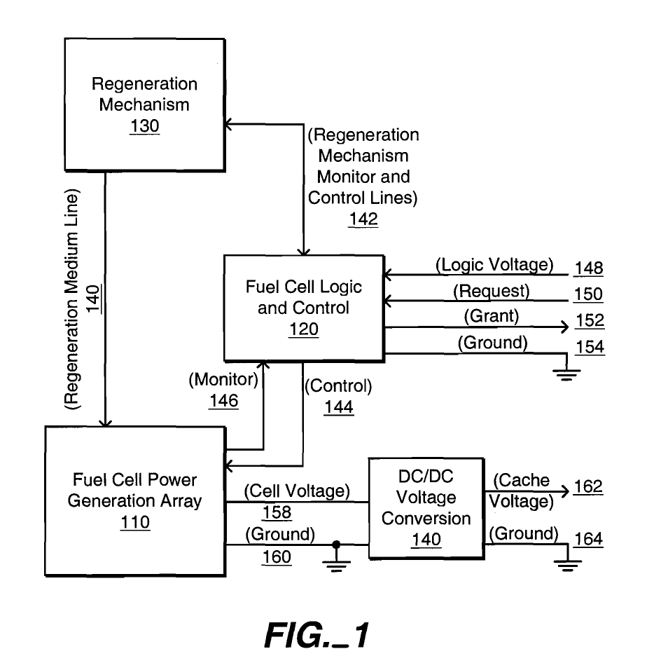

In contrast, FIG. 1 is an exemplary diagram illustrating a fuel cell based backup unit in accordance with an exemplary embodiment of the present invention. As shown in FIG. 1, the fuel cell based backup unit includes a fuel cell logic and control module 120, a regeneration mechanism 130, a fuel cell power generation array 110, and a DC/DC voltage conversion module 140. The fuel cell logic and control module 120 oversees the supplying of backup power by the fuel cell backup unit and controls the regeneration of the fuel cells in the fuel cell power generation array 110.

As shown in FIG. 1, the storage subsystem controller modules (not shown) use a comparatively simple interface to the battery backup unit. The interface consists of a pair of handshake lines, e.g., lines 150 and 152, and a set of power related lines, e.g., lines 148 and 154. The handshake lines 150, 152 are designated as “Request” and “Grant.” Power is supplied to the fuel cell backup unit on the higher voltage supply lines 148 and 154 and the backup unit provides power to the storage subsystem controller via the lower voltage backup lines 162 and 164.

The fuel cell logic and control module 120 sends control signals along line 144 to the fuel cell power generation array 110 to cause power to be supplied to the controller of the storage subsystem along lines 158-160, DC/DC voltage conversion module 140, and lines 162-164 in response to a request from the control module of the storage subsystem via the request line 150. The DC/DC voltage conversion module 140 is used to convert an output DC voltage signal long line 158 to a DC voltage signal useable by the control module of the storage subsystem, which is output along line 162 to the control module of the storage subsystem.

The fuel cell logic and control module 120 monitors the status of the fuel cells in the fuel cell power generation array 110 via monitor signals received along line 146. The line 146 may represent the expression of more than a single signal to identify the health or status of the fuel cell power generation array 110. For example, this line 146 may convey the output voltage level for each cell within the fuel cell power generation array 110. Moreover, the line 146 may also provide signals for identifying the temperatures, pressures, etc. for each fuel cell in the fuel cell power generation array 110. This line 146 may further be used to track operational time to gain an impression of residual capacity.

Based on this status information and algorithms present in the logic of the fuel cell logic and control module 120, the fuel cell logic and control module 120 determines if regeneration of the fuel cells in the fuel cell power generation array 110 is necessary. If so, the fuel cell logic and control module 120 sends control signals to the regeneration mechanism 130 instructing the regeneration mechanism 130 to regenerate the fuel cells in the fuel cell power generation array 110. The fuel cells in the fuel cell power generation array 110 may then be regenerated by supplying fuel, power, or the like, to the fuel cells in the fuel cell power generation array 110 via line 140.

The fuel cell logic and control module 120 monitors the operation of the regeneration mechanism 130 via monitor signals received along line 142. Line 142 may represent a plurality of signal lines that relay information regarding temperatures, pressures, regeneration status, operational durations, and the like. If it is determined that the regeneration mechanism 130 requires servicing based on this information about the regeneration mechanism 130, a notification can be provided to a human user to recharge the regeneration mechanism 130.

The fuel cell based backup unit shown in FIG. 1 is a generic fuel cell based backup unit in accordance with the present invention. Depending on the specific fuel cell used, the connections between elements may be modified slightly. Preferred embodiments of the generic fuel cell based backup unit include the use of either a Zinc-Air fuel cell or a methanol based fuel cell. While these are preferred embodiments, it should be appreciated that the present invention is not limited to such and any type of fuel cell may be used without departing from the spirit and scope of the present invention.

As mentioned above, one of the preferred embodiments of the present invention makes use of Zinc-Air fuel cells in the backup unit of the present invention. The distinction between conventional fuel cells and batteries is blurred by Zinc-Air fuel cells in that they function as regenerative fuel cells. That distinction is based in the fact that the reactant product of a Zinc-Air fuel cell may be repeatedly recycled.

The chemistry of a Zinc-Air fuel cell is quite simple. Zinc pellets are combined with the oxygen in ordinary air in the presence of an electrolyte, such as Potassium Hydroxide. The reaction of the zinc with the oxygen forms zinc oxide. The environmental safety of this material is illustrated by the fact that zinc oxide is used as a topical ointment for the treatment of skin problems and the prevention of sunburn.

In regeneration, using electricity, the chemistry is reversed. By applying a current to the electrolyte in the cell, oxygen is released back into the atmosphere, leaving pure zinc in the electrolyte for use as fuel for the next power cycle. All that needs to be provided is additional air. During this process, no pollutants are emitted. Thus, the Zinc-Air fuel cell is environmentally safe and “friendly.”

Zinc-Air fuel cells are scalable and their recycling speed can be as rapid as required since the speed of recycling is largely controlled by the reaction area size and available recycle (or regeneration) current. Zinc-Air fuel cells may recharge in as little as five minutes and can be considered maintenance free for up to ten years. Of course larger recharge times may be required depending on the amount of energy available to devote to regeneration.

Regeneration units may be separate or may be self-contained within the fuel cell in very compact assemblies. In a preferred embodiment of the present invention, the regeneration units are contained within the fuel cell in order to reduce the size of the overall backup unit. However, for purposes of illustration, the embodiment shown in FIG. 1 and the following embodiments will show the regeneration units as separate from the fuel cell power generation array.

The advantages of fuel cells for use in a backup power unit for a storage subsystem are as follows:

1) the specific energy and energy density for fuel cells is very high;

2) fuel cells are smaller and lighter than conventional batteries for the same energy densities;

3) fuel cells of the same size as conventional batteries produce more power and have longer run times than conventional batteries;

4) fuel cells may be recharged by the addition of more fuel;

5) a “gas gauge” system may be devised to assess the level of available energy within a fuel cell system;

6) fuel cell operation is silent;

7) maintenance costs for fuel cells are very low;

8) materials used in Zinc-Air fuel cells are low cost;

9) fuel cells are transportable and may generate power while in motion; and

10) energy densities may be as much as 350% times those of lead-acid batteries.

In addition to these advantages that are applicable to fuel cells in general, Zinc-air fuel cells have the following additional benefits:

1) Zinc-air fuel cells capable of being regenerated may be “recharged” electrically, analogously to the recharging of more conventional batteries;

2) Zinc-air fuel cell regeneration times are scalable to the users available “recharging” energy.

3) Zinc-Air fuel cells may have operational lives of ten years which is three to five times the life of conventional batteries;

4) the fuel in Zinc-Air fuel cells is non-flammable;

5) Zinc-air fuel cells have no undesirable emissions and are safe for indoor use; and

6) power generation is proportional to the total active area of the cells and the energy output is proportional to the amount of zinc in the cell—this provides the possibility of significant weight advantages over conventional technologies.

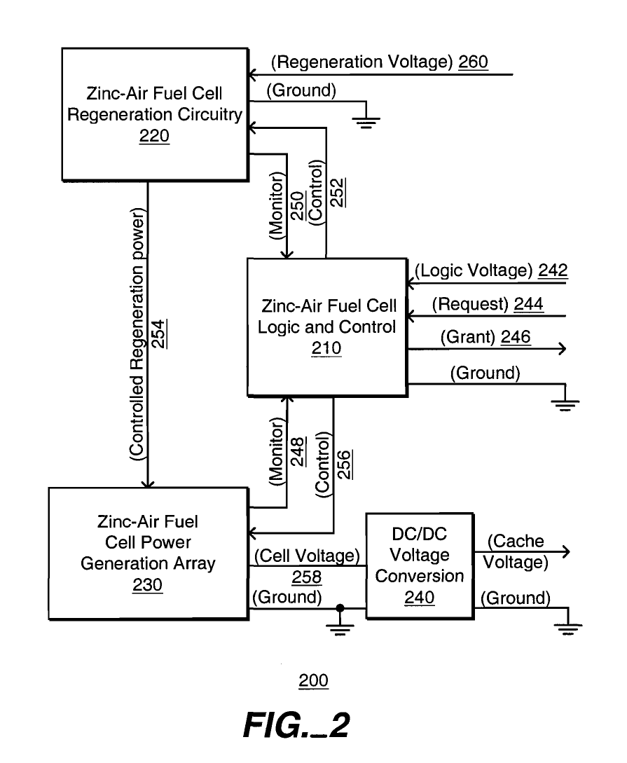

FIG. 2 is an exemplary diagram of a zinc-air fuel cell backup unit in accordance with an exemplary embodiment of the present invention. As shown in FIG. 2, the zinc-air fuel cell backup unit 200 includes a Logic and Control Module 210, a Zinc-Air Fuel Cell Regeneration Circuitry Module 220, a Zinc-Air Fuel Cell Power Generation Array Module 230, and a DC/DC Voltage Conversion Module 240. These elements are coupled to each other via various signal lines 242-252.

The Logic and Control Module 210 oversees the operation of the entire system and maintains control of the fuel cell backup unit. The Logic and Control Module 210 is coupled to the storage subsystem with which the Zinc-Air fuel cell backup unit 200 is working. Power is supplied to the logic of the logic and control module 210 via the logic voltage line 242.

The Logic and Control Module 210 includes logic and monitoring circuitry that keeps track of the Zinc-Air Fuel cells status. When the subsystem asserts a “Request” command it is the function of this logic to determine whether to assert a “Grant” command in response. If the power source is capable of supporting the storage subsystem and no other impediment is acknowledged, then the “Grant” line is asserted and the controllers of the storage subsystem at this point are alerted that caching is allowed for the storage subsystem. The lack of a “Grant” command suspends caching in the storage subsystem.

The circuitry of the Logic and Control Module 210 also selects and implements the remedial actions necessary to bring the Zinc-Air fuel cells to a state where the “Grant” response can be asserted. This generally is the control of regeneration of the Zinc-Air fuel cells in the Zinc-Air Fuel Cell Power Generation Array 230. The Logic and Control Module 210 also serves as the repository for Vital Product Data but that is secondary to the control function that it performs over the operation of the backup unit.

In operation, the Logic and Control Module 210 receives a request for backup power from the exterior storage subsystem via the request signal line 244. The Logic and Control Module 210 correctly asserts and de-asserts the “Grant” signal, along the grant signal line 246, after receiving the “Request” signal via request signal line 244. The correct assertion or de-assertion of the “Grant” signal is based on, for example, a determination of the available capacity or fuel for a minimum acceptable duration.

In response to the request signal, the Logic and Control Module 210 sends a control signal along line 256 to the Zinc-Air Fuel Cell Power Generation Array Module 230 instructing the controller of that module to begin supplying a voltage signal to the DC/DC Voltage Conversion Module 240 along line 258. The Zinc-Air Fuel Cell Power Generation Array Module 230 output voltages are typically about 5.6 volts. This is incompatible with the voltage requirements of most cache RAM which currently, requires voltages in the vicinity of 3.3 volts. The DC/DC voltage conversion module 240 converts the 5.6 volt output voltage of the Zinc-Air Fuel Cell Power Generation Array Module 230 into 3.3 volts which is useable by the cache and outputs the 3.3 voltage signal to the cache.

The Logic and Control Module 210 also oversees regeneration of the Zinc-Air fuel cells in the Zinc-Air Fuel Cell Power Generation Array 230. The cell status of the Zinc-Air fuel cells is monitored via cell status signals sent along signal line 248 from a controller in the Zinc-Air Fuel Cell Power Generation Array 230.

The cell status information sent via signal line 248 may be generated from a sensor, such as a gas-gauge sensor, that monitors the power output of the Zinc-Air fuel cells and indicates whether the Zinc-Air fuel cells are generating adequate available power for continued operation without undergoing a regeneration cycle. A gas-gauge may monitor the power output and indicate a need for regeneration by integrating power generation over time and comparing this with system requirements after reducing the initial capacity by this integrated value to achieve an estimate of residual capacity, for example. If the Zinc-Air fuel cells are not generating adequate power, a signal may be asserted or de-asserted on line 248 that indicates regeneration is necessary by the Zinc-Air Fuel Cell Regeneration Circuitry Module 220. That is, the Zinc-air fuel cell power generation array 230 appropriately selects a “regeneration” and the Zinc-Air Logic and Control Module autonomously decides whether to grant such a request. If the Zinc-Air Logic and Control Module determines to grant the request, then regeneration is performed.

The cell status information is provided to the Logic and Control Module 210 via the Zinc-Air Fuel Cell Power Generation Module 230 and monitor signal line 248. Based on the Status information, the Logic and Control Module 210 sends control signals along signal line 252 to the Zinc-Air Fuel Cell Regeneration Circuitry Module 220 to control the amount of regeneration power applied to the Zinc-Air Fuel Cell Power Generation Array Module 230 by the Zinc-Air Fuel Cell Regeneration Circuitry Module 220 via the line 254.

The regeneration voltage is supplied by the storage subsystem via the regeneration voltage line 260. This regeneration voltage is fed to the Zinc-Air Fuel Cell Regeneration Circuitry Module 220 and all or a portion of the regeneration voltage is provided to the Zinc-Air Fuel Cell Power Generation Array Module 230 under the control of the Zinc-Air Fuel Cell Control and Logic Module 210. The Zinc-Air Fuel Regeneration Circuitry Module 220 performs any required DC/DC conversion and all necessary waveform generation to supply a usable regeneration voltage to the Zinc-Air Fuel Cell Array Module 230.

The Zinc-Air Fuel Cell Regeneration Circuitry Module 220 may be periodically shut down and placed in an inert state by the Logic and Control Module 210. This control function is asserted as required. For example, this control function may be asserted based on the state of the Zinc-Air Fuel Cell Power Generation Array Module 230 as monitored by the Zinc-Air Fuel Cell Logic and Control module 210. The monitoring may represent power integrated over time, for example.

Thus, in normal operation the Zinc-Air Fuel Cell Regeneration Circuitry Module 220 may be enabled or disabled periodically as needed by the Logic and Control Module 210. Likewise, the Zinc-Air Fuel Cell Power Generation Array Module 230 may be similarly enabled or disabled in response to the handshake line states and the regeneration state of the array.

If an abnormal condition is determined to exist, the “Grant” signal line 246 will not be asserted and this will flag the storage subsystem controllers and alert them to a potential fault condition. Such a fault condition may be conveyed electronically to the host and remedial action may be taken. For example, the fault may be conveyed as the loss of a “Grant” signal on line 246.

The operation of this type of backup unit, from the storage subsystem and host machine's viewpoint, is indistinguishable from that of conventional power backup units. The advantages of the fuel cell of the present invention have been discussed above but they include lighter weight, greater power density, longer lifetimes and non-existent disposal issues for discarded cells. Since the power density of this type of fuel cell may exceed that of typical lead-acid batteries, a regeneration cycle may not be required after each partial discharge cycle. Nominally, regeneration cycles may take place as frequently as required. Cells are scaleable to system requirements. Systems of this type may have capacities rated in kilowatt-hours which are somewhat above the usual requirements for Controller Module subsystems but configurations may be constructed where backup units may support several Controller Modules. Interconnections may be accomplished directly or via protected harnesses.

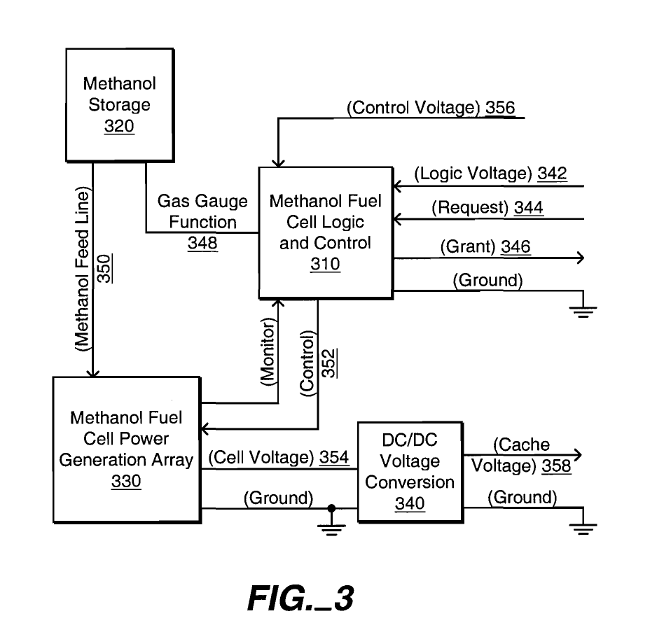

FIG. 3 is an exemplary diagram of a methanol based fuel cell backup unit in accordance with an exemplary embodiment of the present invention. The methanol based fuel cell backup unit 300 shown in FIG. 3 is similar in configuration to the fuel cell backup units illustrated in FIGS. 1 and 2.

In addition to the benefits of fuel cells in general as discussed above, the use of methanol based fuel cells in a backup unit of a storage device allows for the fuel cell cartridges to be “hot swapped” during the operation of storage subsystems, i.e., the fuel cell cartridges may be replaced while the system continues to operate. In addition, as with zinc-air fuel cells, methanol fuel cells have no undesirable emissions and are safe for indoor use.

As shown in FIG. 3, the regeneration voltage of the Zinc-Air fuel cell backup unit may be used as the control voltage 356 for miscellaneous control and monitoring functions where needed. The handshaking lines 344 and 346 remain identical in function to those of the Zinc-Air fuel cell embodiment of FIG. 1 and the supplied voltage line to cache RAM 358 also continues to function as in the Zinc-Air fuel cell backup unit. The primary difference between this embodiment and the previous embodiments is that the methanol fuel cells in the methanol fuel cell power generation array module 330 must be recharged with methanol from the methanol storage module 320.

The chemistry involved in methanol based fuel cells is a simple oxidation reaction that takes place across a semi-permeable membrane. The reaction is controlled in such a way that the electron circulation path is external to the fuel cell and the current flowing within this external path can be caused to do work. Methanol fuel cells generally use electrodes of perforated plastic plated with noble metals such as Platinum and Ruthenium which are used as catalysts. Methanol fuel is supplied to such cells in cartridges, although other mechanisms for supplying methanol fuel may be used without departing from the spirit and scope of the present invention.

Backup voltage is immediately available upon installation. No initial “charging” is required for a methanol fuel cell backup unit upon installation. The methanol fuel cell units remain “charged” indefinitely, until the controller module of the storage subsystem requires backup voltage. In current lead-acid battery backup systems an initial recharge phase is required that may last from 15 minutes to 24 hours. This represents time that the system is precluded from utilizing cache and the caching function is inaccessible. Methanol fuel cell based systems avoid this inaccessibility.

If a conventional battery backup unit is compared to a similar backup unit that comprises a methanol fuel cell, such as that shown in FIG. 3, there are certain obvious differences. First of all there is no charger. Methanol fuel cells are “charged” non-electrically by the addition of methanol fuel. The refueling of a fuel cell may take a few minutes as compared to as many as twenty-four hours for conventional lead-acid based backup system. There is no need in a methanol fuel cell based backup unit for the existence of a charging voltage and thus, a relatively high current voltage source is eliminated by the use of a methanol fuel cell backup unit.

The low current required from a battery backup unit (30 ma for 1 GB of backed up RAM) suggests that the actual fuel cell can be quite diminutive. The duration requirements are met by sizing the “fuel tanks.” The logic and control module 310 may monitor the level of methanol fuel in the methanol storage module 320 using, for example, a gas gauge functional analog.

The charge state of lead-acid batteries must be constantly known and charging is selected accordingly. The “gas gauge” function of the logic and control module 310 of the present invention may alert the user and the rest of the storage subsystem to “refuel” the methanol fuel cell or to suspend caching until the methanol fuel level is brought back to the recommended level.

Lead acid battery based backup units are not immediately available to storage subsystems for between fifteen minutes and twenty-four hours while the cells are brought up to their initial charge state. This period of time where caching is suspended is eliminated through the use of methanol based fuel cells. That is, if fuel is available within the cell, caching may begin immediately.

At initial installation of a methanol fuel cell into the methanol fuel cell power generation array 330, a methanol fuel cartridge may be installed in the methanol storage module 320. The installation of the methanol fuel cartridge may involve a “hypodermic” needle puncturing a rubber gland on the methanol fuel cartridge. Fluidics within the methanol fuel cell maintain flow and fuel distribution within the methanol fuel cell.

Current is available instantly upon installation and no initial charge cycle is required. Backup is immediately available and the unit remains operational and in reserve until its services are required. This waiting period may amount from seconds to years. The methanol fuel cell backup unit remains viable with no external maintenance required.

With no external current flow, the reactions are inhibited and do not proceed. The external flow of current represents one of the electron paths in the oxidation reaction taking place in the cell.

Recharging a methanol fuel cell backup unit is accomplished by the replacement of the methanol fuel cartridge in the methanol storage module 320. The supervisory “gas gauge” function may alert the user to the need to make such a cartridge swap. The combustion products of a methanol fuel cell are non-toxic and there no disposal issues with this type of power source.

The above embodiments make use of fuel cells rather than lead acid batteries to provide backup power to storage subsystems. However, there are potential situations where the combination of the two technologies may have distinct advantages. The present invention, in addition to the exclusively fuel cell based backup units discussed above, provides a hybrid fuel cell and lead acid battery backup unit for providing backup power to storage subsystems.

The existence of the paralleled technology of fuel cells and lead acid batteries in the hybrid approach of the present invention allows the possibility of an electrical charge system for the lead acid battery accompanying a chemical charge system for the same battery.

Conceptually, this means that the lead-acid battery functions as the primary reservoir for charge and means are provided for either electrically or chemically charging this charge reservoir. This hybrid approach also provides the possibility of autonomous operation where the fuel cell tops off the lead acid cells on a semi-continuous basis prior to their installation into a subsystem. This provides a means for maintaining the charge state of an unconnected backup unit. This would result in any such backup unit being at full charge at installation.

The hybrid approach also has the potential of vastly extending the shelf life of the backup unit. This is because the logic and control module has the ability to sense the level of charge on the batteries and authorize fuel cell operation to establish a full charge condition. This recharge may take place on the shelf while the backup unit awaits installation. Additional fuel may be added as necessary to support this self initiated function.

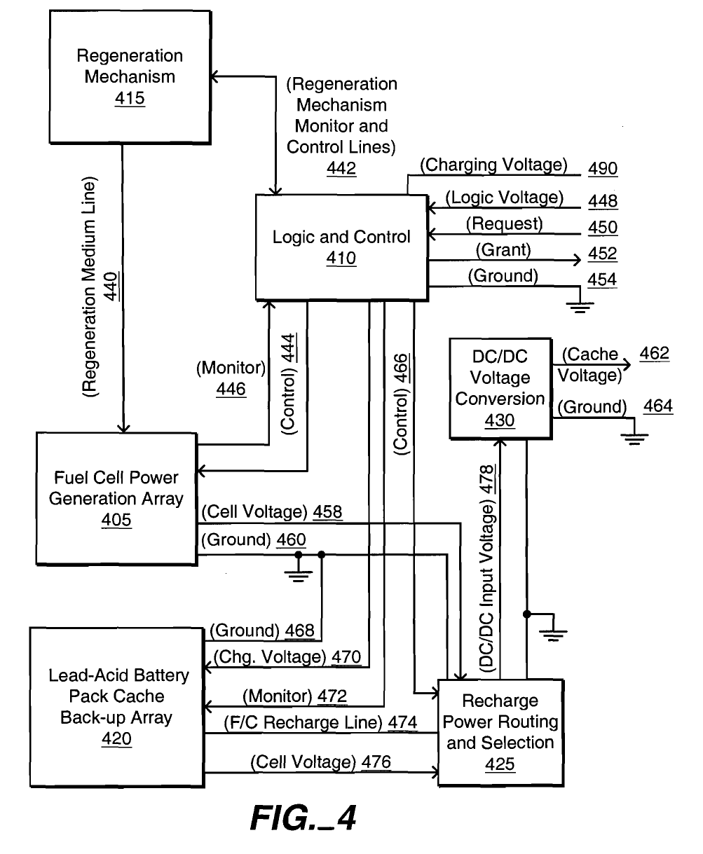

FIG. 4 is an exemplary diagram of a hybrid fuel cell and lead acid battery backup unit in accordance with an exemplary embodiment of the present invention. As shown in FIG. 4, the hybrid fuel cell/lead-acid battery backup unit includes a fuel cell power generation array 405, a logic and control module 410, a regeneration mechanism 415, a lead-acid battery pack cache backup array 420, a recharge power routing and selection module 425, and a DC/DC voltage conversion module 430. In the hybrid fuel cell/lead-acid battery backup unit of FIG. 4, the logic and control module 410 controls the overall operation of the backup unit, monitors the fuel cell power generation array 405, the regeneration mechanism 415 and the lead-acid battery pack cache back-up array 420.

In the hybrid backup unit of FIG. 4, the voltage output from the fuel cell power generation array 405 may be used to provide power to the storage subsystem in a manner similar to that described above with regard to the embodiments in FIGS. 1-3, and/or may provide power to be used to recharge the lead-acid battery pack cache backup array 420 which may be the source of backup power. The recharge power routing and selection module 425 is controlled by the logic and control module 410 to determine which operation, backup power and/or recharge of the lead-acid battery pack, is to be performed by the fuel cell power generation array 405. Recharge power may be provided to the lead-acid battery pack cache backup array 420 via the line 474 backup power may be provided to the DC/DC voltage conversion module 430 via line 478 from either the fuel cell power generation array 405 via line 458 or the lead-acid battery pack 420 via line 476. A charge voltage may also be provided to the lead-acid battery pack cache backup array 420 from a charging voltage received along lines 470 and 490 from the host machine. Other operations of the elements 410-430 are similar to that described in the previous embodiments shown in FIGS. 1-3.

In addition to the above, with the hybrid approach, the logic and control module may be defined as programmable. Thus, the user may make decisions about how the charge state is to be maintained, how voltage sources are switched to loads and when, and the like. These decisions may be provided to the logic and control module in order to program the logic and control module to operate accordingly.

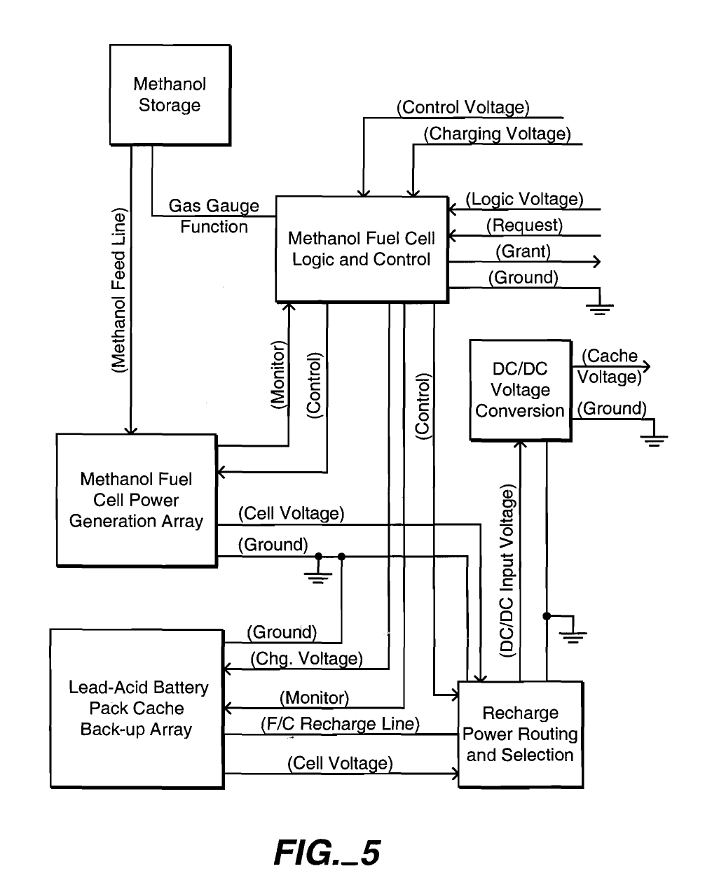

FIG. 5 is an exemplary diagram of a hybrid methanol fuel cell and lead acid battery backup unit in accordance with an exemplary embodiment of the present invention. The embodiment shown in FIG. 5 is a specific implementation of the embodiment of FIG. 4 in which methanol fuel cells are utilized and a methanol storage module is utilized for regenerating the methanol fuel cells in the methanol fuel cell power generation array. The hybrid methanol fuel cell/lead-acid battery backup unit of FIG. 5 operates as discussed above with regard to the embodiments described in FIGS. 3 and 4. It should be appreciated that the same hybrid approach may be taken using the Zinc-Air fuel cells of the embodiment shown in FIG. 2 without departing from the spirit and scope of the present invention.

Thus, the present invention provides fuel cell based backup units for use with storage subsystems of computing devices, such as RAM cache of a computing device. The present invention overcomes the problems associated with lead-acid batteries and the other alternatives discussed above.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1-10. (canceled)

11. A method for providing backup power to a storage subsystem of a computing device, comprising:
receiving a request from the storage subsystem for backup power via an interface between a controller and the storage subsystem wherein the controller is coupled to at least one fuel cell;
monitoring a status of the at least one fuel-cell;
asserting a grant signal to the storage subsystem via the interface, wherein the grant signal indicates that caching by the storage subsystem is allowed; and
de-asserting the grant signal to the storage subsystem via the interface, wherein de-asserting the grant signal suspends caching in the storage subsystem, wherein the grant signal is asserted or de-asserted based on the status of the at least one fuel cell.

12. The method of claim 11, wherein the at least one fuel cell is coupled to at least one lead acid battery to form a hybrid fuel cell and lead-acid battery cache backup array.

13. The method of claim 12, further comprising:
recharging the at least one lead-acid battery on a semi-continuous basis prior to connection of the hybrid fuel cell and lead-acid battery backup array to the storage subsystem, wherein a charge state of the at least one lead-acid battery is maintained prior to an unconnected hybrid fuel cell and lead-acid battery backup array, and wherein the hybrid fuel cell and lead-acid battery backup array is at a full charge when the hybrid fuel cell and lead-acid battery backup array is connected to the storage subsystem.

14. The method of claim 11, wherein the at least one fuel cell a methanol based fuel cell, and further comprising:
providing methanol fuel to the at least one fuel cell to cause regeneration of the fuel cell, by a regeneration mechanism.

15. The method of claim 12, wherein the at least one fuel cell comprises a Zinc-Air fuel cell, and further comprising:
providing a current to the at least one fuel cell to regenerate the fuel cell, by a regeneration mechanism.

16. The method of claim 14 further comprising:
alerting the storage subsystem to suspend caching until a methanol fuel level of the fuel cell is brought back to a recommended level.

17. The method of claim 11, further comprising;
converting a direct current output voltage of a fuel cell power generation array to a direct current voltage that is useable by the storage subsystem of the computing device.

18. The method of claim 11, wherein the storage subsystem of the computing device is a RAM cache.

19. The method of claim 12 further comprising:
providing a recharge voltage to the at least one lead-acid battery by the at least one fuel cell; and
providing backup power to the storage subsystem using a power output by the at least one lead-acid battery.

20. The method of claim 19, further comprising:
selecting by a recharge power routing and selection modules, recharge the at least one lead-acid battery using an output from the at least one fuel cell, and
selecting by the recharge power routing and selection module when to provide output from the at least one fuel cell to the storage subsystem as backup power wherein the recharge power routing and selection module determines whether the output is used to recharge the at least one lead-acid battery or provide power to the storage subsystem.

21. A method for providing backup power to a storage subsystem of a computing device by a hybrid fuel cell and lead-acid battery backup array, the computer implemented method comprising:
responsive to a determination that the hybrid fuel cell and lead-acid battery backup array is capable of supporting the storage subsystem, asserting a grant signal to the storage subsystem, wherein the hybrid fuel cell and lead-acid battery backup array comprises at least one lead-acid battery coupled to at least one fuel cell, and wherein the grant signal indicates that caching by the storage subsystem is allowed; and
responsive to a determination that the hybrid fuel cell and lead-acid battery backup array is incapable of supporting the storage subsystem, de-asserting the grant signal to the storage subsystem, wherein de-asserting the grant signal suspends caching in the storage subsystem, wherein the grant signal is asserted or de-asserted based on a status of the hybrid fuel cell and lead-acid battery backup array.

22. The method of claim 21 further comprising:
providing a recharge voltage to the at least one lead-acid battery, by the at least one fuel cell, wherein an output of the at least one fuel cell is only used to recharge the lead-acid battery.

23. The method of claim 21 further comprising:
providing a recharge voltage to the at least one lead-acid battery, by the at least one fuel cell, wherein an output of the at least one fuel cell is used to recharge the lead-acid battery and provide backup power to the storage subsystem.

24. The method of claim 21 further comprising:
responsive to a de-assertion of the grant signal by the hybrid fuel cell and lead-acid battery backup array, suspending caching in the storage subsystem, by the storage subsystem.

25. The method of claim 21 further comprising:
responsive to a de-assertion of the grant signal by the hybrid fuel cell and lead-acid battery backup array, implementing remedial actions necessary to bring the hybrid fuel cell and lead-acid battery backup array to a state where the grant signal can be re-asserted.

26. The method of claim 21 further comprising:
responsive to a determination that fuel is available to provide power by the hybrid fuel cell and lead-acid battery backup array for a minimum acceptable duration, asserting the grant signal.

27. The method of claim 21 further comprising:
monitoring a power output of the hybrid fuel cell and lead-acid battery backup array by a gas-gauge; and
indicating, by the gas-gauge, a need to regenerate at least one fuel cell associated with the hybrid fuel cell and lead-acid battery backup array based on the power output, wherein the at least one lead-acid battery provides power to the storage subsystem when the at least one lead-acid battery is regenerated.

28. The method of claim 21 further comprising:
recharging the at least one lead-acid battery on a semi-continuous basis prior to connection of the hybrid fuel cell and lead-acid battery backup array to the storage subsystem, wherein a charge state of the at least one lead-acid battery is maintained prior to an unconnected hybrid fuel cell and lead-acid battery backup array, and wherein the hybrid fuel cell and lead-acid battery backup array is at full charge at connection to the storage subsystem.

29. The method of claim 21 further comprising:
allowing caching in the storage subsystem, by the storage subsystem, in response to receiving the grant signal from the hybrid fuel cell and lead-acid battery backup array.

30. A method for providing backup power to a storage subsystem of a computing device by a hybrid fuel cell and lead-acid battery backup array, the computer implemented method comprising:
receiving a request for backup power from the storage subsystem;
determining whether the hybrid fuel cell and lead-acid battery backup array is capable of supporting power requirements of the storage subsystem for a minimum acceptable duration;
responsive to a determination that an available capacity of the hybrid fuel cell and lead-acid battery backup array is sufficient to support the power requirements of the storage subsystem for the minimum acceptable duration, converting an output voltage of a fuel cell power generation array of the hybrid fuel cell and lead-acid battery backup array to a direct current voltage that is useable by the storage subsystem of the computing device and asserting a grant signal to the storage subsystem, wherein the grant signal indicates that caching by the storage subsystem is allowed;
responsive to a determination that an available capacity of the hybrid fuel cell and lead-acid battery backup array is insufficient to support the power requirements of the storage subsystem for the minimum acceptable duration, de-asserting the grant signal to the storage subsystem via the interface, wherein de-asserting the grant signal suspends caching in the storage subsystem, wherein the grant signal is asserted or de-asserted based on a status of the at least one fuel cell; and
responsive to de-asserting the grant signal, implementing remedial actions to bring a status of the hybrid fuel cell and lead-acid battery backup array to a state where the grant signal can be re-asserted.
